(19) United States
(12) Patent Application Publication
(10) Pub. No.: US 2008/0303483 A1
(43) Pub. Date: Dec. 11, 2008

(54) External Versatile Battery with Power Saving Mode

(75) Inventor: Tadashi Okuto, New York, NY (US)

Correspondence Address: Oppedahl Patent Law Firm LLC, P.O. BOX 4850, FRISCO, CO, 80443-4850, US

(73) Assignee: SENDYNE CORPORATION, New York, NY (US)

(21) Appl. No.: 11/570,414

(22) PCT Filed: Jun. 10, 2005
(86) PCT No.: PCT/IB2005/051932

§ 371 Date: Dec. 11, 2006

Related U.S. Application Data
(60) Provisional application No. 60/581,003, filed on Jun. 10, 2004.

(51) Int. Cl. H02J 7/00

(52) U.S. Cl. 320/128

(57) ABSTRACT

A versatile external battery system has a built-in charger. Using particular plugs containing capacitors, the system can connect to many makes and models of notebook computer. The capacitor configures an oscillator which controls a DC-to-DC converter. In this way, disconnecting the plug turns off the oscillator and eliminates power leakage.

### CROSS-REFERENCE TO RELATED APPLICATIONS

This application claims priority from U.S. application No. 60/581,003, which application is incorporated herein by reference for all purposes.

### BACKGROUND

Mobile professionals have, in recent years, seen a reduction in the number of cables that must be connected to a notebook computer whilst traveling. An external pointing device or external keyboard may be connected via Bluetooth rather than a cable. A connection to a computer network may be by means of an 802.11b wireless link rather than an Ethernet cable. A connection to the Internet may be by means of a wireless GPRS (general packet radio service) or 1× or EVDO (evolution data only) or Edge (enhanced data rates for global evolution) or UMTS (universal mobile telecommunications system) connection.

Despite this progress, one cable stubbornly remains as a necessity for use of a notebook computer on the road—the power cable. As provided by the manufacturer, a notebook computer will typically have an internal rechargeable battery and an external charger for drawing upon AC (mains) power to recharge that battery. Optionally, the manufacturer may offer an external charger for drawing upon an automobile 12 volt cigarette lighter power source to recharge the notebook battery. Such a charger also typically can draw upon an Empower connector on an airplane for power to recharge the battery and to operate the computer. But in each of these cases the user is forced to connect a cable from the computer to some fixed power source.

In recent years another approach has been attempted, namely an external rechargeable universal battery to provide power to a notebook computer. Following this approach, a system comprises a rechargeable battery and a switching power supply that is intended to be able to produce any of a number of particular voltages. Detachable plugs are provided to connect between the system and a particular notebook computer. The plug provides an electrical connection between the system and the computer, as well as providing a mechanical match of pin or conductor configuration to match the computer. In addition, the plug contains a programming resistor. The resistor connects with a control circuit within the system. The value of the resistor determines which of the particular voltages will be produced by the switching power supply. In this way, a particular selection of plug may provide physical and electrical compatibility with a particular make and model of notebook computer.

At least some embodiments of this approach offer the potential drawback that the control circuit and switching power supply are always on. This leads to power leakage.

Another potential drawback to this approach is that a resistor may not be the best choice for a way of determining the voltage to be generated.

Patents that attempt to address some aspects of external power include U.S. Pat. No. 6,624,616 to Frerking et al., U.S. Pat. No. 5,530,296 to Masaki, U.S. Pat. No. 6,441,589 to Frerking et al., and U.S. Pat. No. 6,495,932 to Yoshimizu et al.

It would be very desirable to have an external power supply system with a power saving mode to eliminate power leakage,

### SUMMARY OF THE INVENTION

A versatile external battery system has a built-in charger. Using particular plugs containing capacitors, the system can connect to many makes and models of notebook computer. The capacitor configures an oscillator which controls a DC-to-DC converter. In this way, disconnecting the plug turns off the oscillator and eliminates power leakage.

### DESCRIPTION OF THE DRAWING

The invention will be described with respect to a drawing in several figures. Where possible, like elements are designated with like reference designations.

FIG. 1 shows a prior-art external power supply.

FIG. 2 shows in functional block diagram form a system according to a first embodiment of the invention.

FIG. 3 shows in schematic diagram form the system of FIG. 2.

FIG. 4 shows in functional block diagram form a system according to a second embodiment of the invention.

FIG. 5 shows in schematic diagram form the system of FIG. 4.

### DETAILED DESCRIPTION

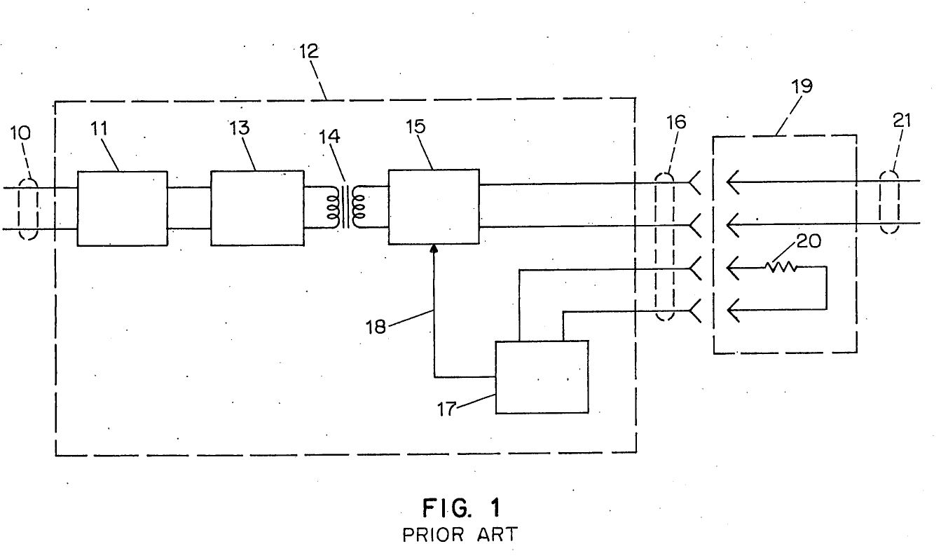

FIG. 1 shows a prior-art external power supply 12. Mains (AC) power is supplied at 10. This power is rectified at 11 and the resulting DC is passed to a high-frequency switching circuit 13. The high-frequency output of the circuit 13 is provided to a transformer 14. The output of the transformer 14 passes to a rectifier 15 and then reaches equipment (omitted for clarity in FIG. 1) by power lines 21.

The motivation for employing a high frequency circuit 13 is that it permits a much smaller transformer 14 as compared with the transformer that would be needed if fifty- or sixty-cycle AM power were supplied directly to the transformer 14.

A plug 19 is connected to the supply 12. The plug 19 provides mechanical compatibility for the conductors 21 to match the pin or connector configuration required to mate with the equipment to be powered (omitted for clarity in FIG. 1). The plug 19 also provides a programming resistor 20. The value of the programming resistor 20 affects a control circuit 17. The control circuit 17 controls the rectifier 15 and associated circuitry by means of control line 18. In this way it is desired to cause the rectifier 15 and associated circuitry to produce whatever DC voltage level is required at the equipment to be powered. For each make and model of equipment to be powered, a respective plug 19 is employed to provide both electrical and mechanical compatibility. An example of such a system may be seen in the above-mentioned U.S. Pat. No. 6,495,932 to Yoshimizu et al.

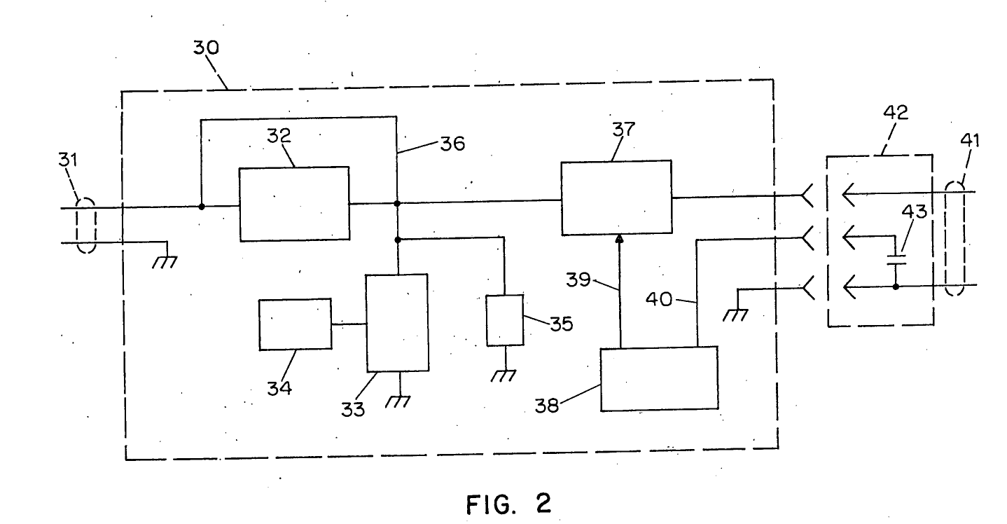

FIG. 2 shows in functional block diagram form a system 30 according to a first embodiment of the invention. Power is received at connector 31, for example an input of 20 volts DC from an external AC adaptor. This power passes to charger 32 which is used to charge battery 33. In a typical embodiment the battery 33 comprises four lithium-ion cells in series.

Optionally a “gas gauge” 35 is provided. Upon the press of a button, the gas gauge is actuated and it illuminates selected LEDs in a (typical) five-LED array to indicate the extent to which the battery is full (charged) or empty (discharged). Such gas gauge circuits are well known and the particular gas gauge circuit employed is not specific to the invention.

Also provided is a “protection” circuit 34. This circuit reads the potential across each of the four lithium-ion cells. If any one cell reads a much smaller potential than expected during charging, then it is inferred that the cell has failed in a low-impedance or “shorted” state. Such a state would risk overheating if charging current were to continue to be applied, and the protection circuit 34 cuts off the charging current.

Another condition to be protected against is reverse charging of a single cell at a time when the battery is being used to power equipment. When discharge current is flowing through the battery 33, there is a possibility that one of the cells may discharge sooner than the others. When this happens there is the risk that the remaining three cells would continue to generate a current, thereby continuing to provide power at the equipment. If this were to happen, the current would reverse-charge the discharged cell, likely causing permanent damage to that cell. The protection circuit 34 cuts off current flow in such an event, to protect the discharged cell from damage.

Such protection circuits are well known and the particular protection circuit employed is not specific to the invention.

Optional line 36 may permit bypassing the battery 33 and charger 32 in the special case where there is power available at 31 at the same time that it is desired to power the equipment.

A plug 42 is used to connect the system 30 to a particular make and model of equipment to be powered, omitted for clarity in FIG. 2. Typically the equipment to be powered is a notebook computer. The plug 42 has connector pins 41 which connect to the equipment to be powered. These pins are mechanically disposed to provide mechanical compatibility with the equipment to be powered.

Plug 42 contains a capacitor 43. This capacitor is connected via line 40 with an oscillator 38. In a typical embodiment the oscillator 38 is disposed to oscillate at any of at least two predetermined frequencies as a function of the value of the capacitor. The oscillator 38 causes the switching power supply 37 to yield a particular desired output voltage to match the requirements of the external equipment to be powered.

In a typical embodiment a first frequency is used to generate about sixteen volts for a notebook computer using a three-cell internal lithium-ion battery, and a second frequency is used to generate about nineteen volts for a notebook computer using a four-cell internal lithium-ion battery. The absence of oscillation puts the switching power supply into its power saving mode, thus eliminating power leakage.

As will be appreciated, if the external capacitor 43, is not connected, then the oscillator 38 does not oscillate. This puts the circuitry 37 into a power saving mode.

The consequence is an elimination of power leakage while the system 30 is in this power saving mode.

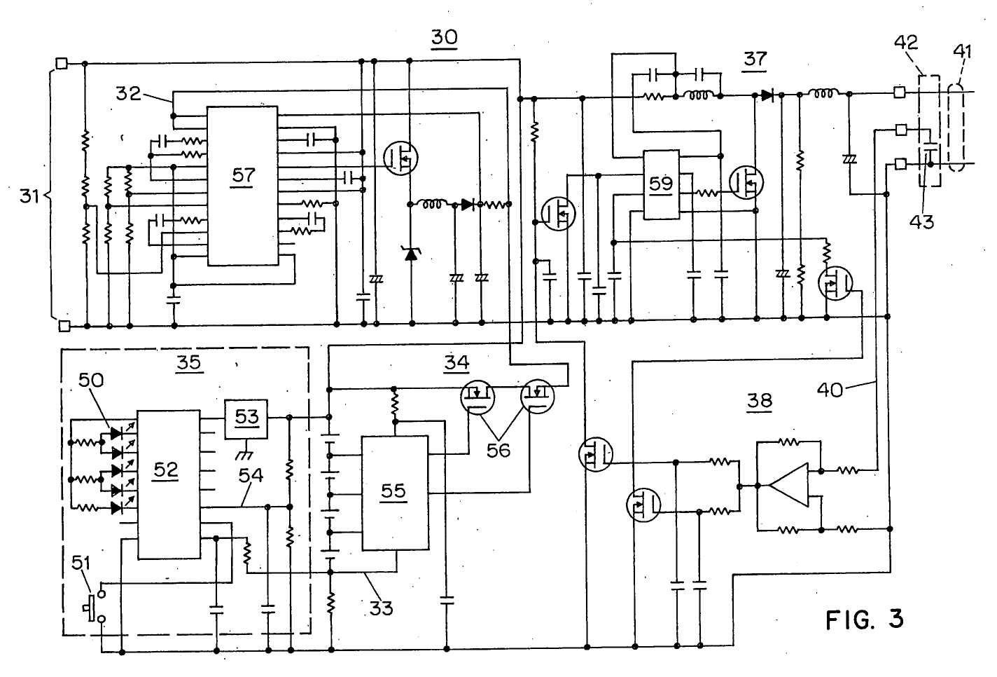

FIG. 3 shows in schematic diagram form the system 30 of FIG. 2. Charger 32 is seen in component-level detail including charging integrated circuit 57. Gas gauge 35 comprises voltage regulator 53, and signal line 54 which is indicative of the voltage at the battery 33. LEDs 50, disposed in a bar graph, are selectively illuminated in response to a user input at push button 51.

Protection circuit 34 may also be seen. This circuit includes solid-state switches 56 and integrated circuit 55 which connects with each terminal of each of the cells of the battery 33.

Switching power supply 37 may also be seen, including integrated circuit 59. As will be seen in FIG. 3, capacitor 43 connects via line 40 to oscillator 38. This oscillator 38 sends control signals to the switching power supply 37.

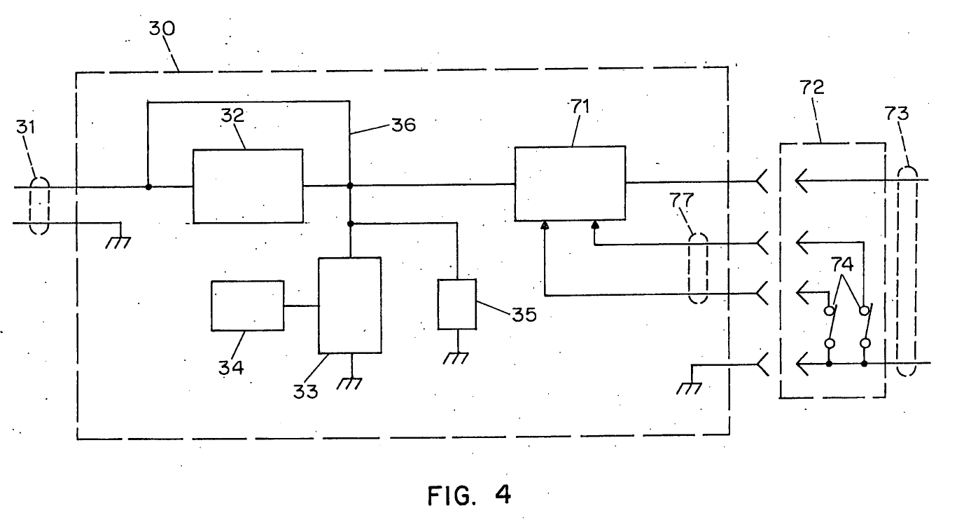

FIG. 4 shows in functional block diagram form a system according to a second embodiment of the invention. In this embodiment, the plug 72 contains jumper locations 74. The presence or absence of these jumpers is communicated by lines 77 to the switching power supply 71, thereby determining the output voltage therefrom. In this way the plug 72 provides mechanical and electrical compatibility with the equipment to be powered (omitted for clarity in FIG. 4).

In an exemplary embodiment the power supply 71 is disposed to go into power saving mode when plug 72 is disconnected, thereby eliminating power leakage.

In exemplary embodiments of either of the systems of FIGS. 2-3 or FIGS. 4-5, there are typically two possible output voltages—one output voltage of about 16 volts to serve a notebook computer containing three lithium-ion cells in its internal battery, and another output voltage of about 19 volts to serve a notebook computer containing four lithium-ion cells in its internal battery.

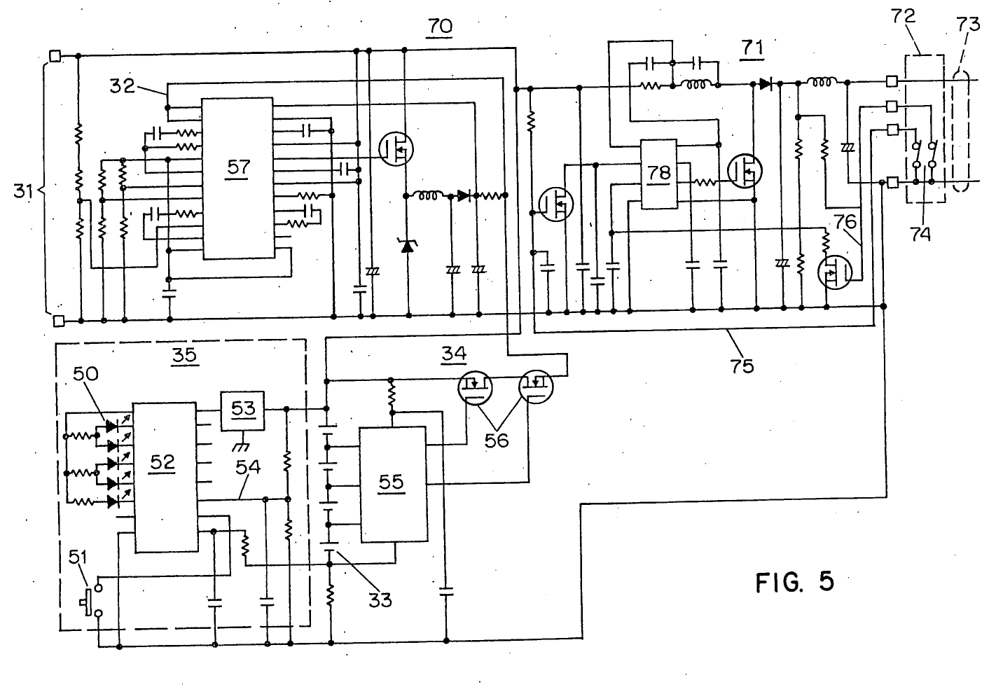

FIG. 5 shows in schematic diagram form the system of FIG. 4. Switching power supply 71 contains integrated circuit 78. Signal lines 75, 76 communicate the presence or absence of jumpers 74.

Those skilled in the art will have no difficulty devising-myriad obvious improvements and variants of the invention without undue experimentation, all of which are intended to be encompassed within the claims which follow.

1. A system comprising a power supply and first and second connectors, each of the first and second connectors disposed to connect with the power supply and with external equipment;
each of said first and second connectors having at least a first, second, and third conductor connecting with the power supply;
each of said first and second connectors having a respective capacitor between the second and third conductors;
the capacitor in the first connector having a capacitance differing from that of the capacitor in the second connector;
the power supply having first, second and third conductors disposed to mate with the first, second, and third conductors of one of the connectors;
the system further comprising an oscillator connected with the second and third conductors of the power supply;
the oscillator disposed to oscillate at either of two frequencies depending on which of the two capacitances is connected thereto by means of the second and third conductors of the power supply;
the power supply disposed to supply either of two voltages at the first and third conductors of the power supply depending on which of the two frequencies is developed at the oscillator;
each connector providing a connection from its first and third conductors to the external equipment;
the power supply and the oscillator contained within a single housing.

2. The system of claim 1 wherein the two voltages comprise about sixteen volts and about nineteen volts.

3. The system of claim 1 further comprising a battery within the single housing, the battery powering the power supply.

4. The system of claim 3 further comprising a charger within the single housing, the charger receiving external power and disposed to charge the battery.

5. A system comprising a power supply having first, second and third conductors disposed to mate with first, second, and third conductors an external connector;
the system further comprising an oscillator connected with the second and third conductors of the power supply;
the oscillator disposed to oscillate at either of two frequencies depending on which of two capacitances is connected thereto by means of the second and third conductors of the power supply;
the power supply disposed to supply either of two voltages at the first and third conductors of the power supply depending on which of the two frequencies is developed at the oscillator;
the power supply and the oscillator contained within a single housing.

6. The system of claim 5 wherein the two voltages comprise about sixteen volts and about nineteen volts.

7. The system of claim 5 further comprising a battery within the single housing, the battery powering the power supply.

8. The system of claim 7 further comprising a charger within the single housing, the charger receiving external power and disposed to charge the battery.

9. A system comprising a power supply and first and second connectors, each of the first and second connectors disposed to connect with the power supply and with external equipment;
each of said first and second connectors having at least a first, second, third and fourth conductor connecting with the power supply;
each of said first and second connectors having a combination of jumpers between the second and fourth conductors and third and fourth conductors;
the jumper combination in the first connector differing from that of the jumper combination in the second connector;
the power supply having first, second, third and fourth conductors disposed to mate with the first, second, third and fourth conductors of one of the connectors;
the power supply connected with the second, third and fourth conductors of the power supply;
the power supply disposed to supply either of two voltages at the first and fourth conductors of the power supply depending on which of the two combinations of jumpers is present;
each connector providing a connection from its first and fourth conductors to the external equipment.

10. The system of claim 9 wherein the two voltages comprise about sixteen volts and about nineteen volts.

11. The system of claim 9 further comprising a battery within the single housing, the battery powering the power supply.

12. The system of claim 11 further comprising a charger within the single housing, the charger receiving external power and disposed to charge the battery.

13. A system comprising a power supply;
the power supply having first, second, third and fourth conductors disposed to mate with first, second, third and fourth conductors of an external connectors;
the power supply disposed to supply either of two voltages at the first and fourth conductors of the power supply depending on which of two combinations of jumpers is present at the second, third, and fourth connectors.

14. The system of claim 13 wherein the two voltages comprise about sixteen volts and about nineteen volts.

15. The system of claim 13 further comprising a battery within the single housing, the battery powering the power supply.

16. The system of claim 15 further comprising a charger within the single housing, the charger receiving external power and disposed to charge the battery.

17. A method for use with a system for powering external equipment, the method comprising the steps of:
connecting a connector between the system and the external equipment, the connector having first, second, and third conductors connecting with respective first, second and third conductors at the system, the connector having a capacitor connected between the second and third conductors, the capacitor having a capacitance;
oscillating within an oscillator within the system, the oscillating taking place at a frequency that is dependent upon the capacitance of the capacitor;
generating a voltage at a power supply within the system, the voltage dependent upon the frequency of oscillation; and
supplying the voltage by means of the first and third conductors to the external equipment.

18. The method of claim 17 further comprising the step, performed before the connecting step, of selecting a particular connector from among at least first and second connectors, the first and second connectors each having a respective capacitor with a capacitance differing from the other;
the connecting step comprising connecting the selected connector to the system.

19. The method of claim 17 further comprising the step of disconnecting the connector from the system;
halting the oscillation; and
as a consequence of the halting of the oscillation, putting the power supply into a power-saving mode.

20. A method for use with a system for powering external equipment, the method comprising the steps of:
connecting a connector between the system and the external equipment, the connector having first, second, third and fourth conductors connecting with respective first, second, third and fourth conductors at the system, the connector having a combination of jumpers connected between the second and fourth and third and fourth conductors;
generating a voltage at a power supply within the system, the voltage dependent upon a connected combination of jumpers; and
supplying the voltage by means of the first and fourth conductors to the external equipment.
